(19) United States
(12) Patent Application Publication
(10) Pub. No.: US 2022/0012345 A1
(43) Pub. Date: Jan. 13, 2022

(54) HISTORY OUTPUT APPARATUS, CONTROL METHOD, AND PROGRAM

(71) Applicant: NEC Corporation, Minato-ku, Tokyo (JP)

(72) Inventors: Kazuhiko ISOYAMA, Tokyo (JP); Yoshiaki SAKAE, Tokyo (JP); Jun NISHIOKA, Tokyo (JP); Etsuko ISHIHARA, Tokyo (JP)

(73) Assignee: NEC Corporation, Minato-ku, Tokyo (JP)

(21) Appl. No.: 17/431,508

(22) PCT Filed: Feb. 20, 2019
(86) PCT No.: PCT/JP2019/006226

§ 371 Date: Aug. 17, 2021

(51) Int. Cl. G06F 21/57; G06F 21/55

(52) U.S. Cl. CPC G06F 21/577; G06F 2221/034; G06F 21/552

(57) ABSTRACT

A history output apparatus (2000) acquires an abnormal event history (10) being information representing an abnormal event occurring in a target system (100), and determines a kind of the abnormal event represented by the abnormal event history (10). When a kind of the determined abnormal event is a first kind, the history output apparatus (2000) determines a terminal (110) in which the abnormal event occurs, as an output target terminal. Further, the history output apparatus (2000) also determines another terminal (110) performing communication with the terminal (110) in which the abnormal event occurs at or before a point when the abnormal event occurs, as an output target terminal. When the abnormal event represented by the acquired abnormal event history (10) is an abnormal event occurring in the output target terminal, the history output apparatus (2000) outputs information relating to the abnormal event.

### TECHNICAL FIELD

The present invention relates to a technique for managing information relating to an abnormality occurring in a system.

### BACKGROUND ART

A technique for outputting information relating to an abnormal event occurring in a system is developed. For example, PTL 1 discloses a technique of recording a command affecting a state of a system among commands executed in the system, and, when an abnormality is sensed in the system, outputting a command executed within a predetermined time before occurrence of the abnormality.

### RELATED DOCUMENT

Patent Document

[PTL 1] Japanese Patent Application Publication No. 2014-10761

### SUMMARY OF THE INVENTION

### Technical Problem

When an amount of information output in relation to an abnormality occurring in a system is too large, analysis work of the information becomes complicated. As a result, such a problem that it becomes easy to overlook an important abnormality arises. In this respect, when an abnormal event is sensed, a technique in PTL 1 outputs a log of a past command regardless of whether the abnormality is a minor abnormality or a major abnormality. Thus, it is considered that information (a log of a command) to be output increases.

The present invention has been made in view of the problem described above, and one object thereof is to provide a technique for easing handling of information relating to an abnormal event.

### Solution to Problem

A first history output apparatus according to the present invention includes: 1) an acquisition unit that acquires an abnormal event history representing an abnormal event occurring in a terminal; 2) a kind determination unit that determines whether a kind of the abnormal event represented by the acquired abnormal event history is a predetermined kind; 3) a terminal determination unit that determines, when a kind of the abnormal event is the predetermined kind, a terminal in which the abnormal event occurs, and another terminal communicating with the terminal at or before a point when the abnormal event occurs, as output target terminals; and 4) an output unit that outputs, when the abnormal event represented by the acquired abnormal event history is an abnormal event occurring in the output target terminal, output information relating to the abnormal event.

A second history output apparatus according to the present invention includes: 1) an acquisition unit that acquires an abnormal event history representing an abnormal event occurring in a terminal; 2) a kind determination unit that determines whether a kind of the abnormal event represented by the acquired abnormal event history is a predetermined kind; 3) a terminal determination unit that determines, when a kind of the abnormal event is the predetermined kind, a terminal in which the abnormal event occurs, as an output target terminal; and 4) an output unit that outputs, when the abnormal event represented by the acquired abnormal event history is an abnormal event occurring in the output target terminal, output information relating to the abnormal event.

When a certain terminal is determined as the output target terminal, the output unit further outputs output information relating to an abnormal event occurring in the terminal earlier than the determination.

A first control method according to the present invention is executed by a computer. The control method includes: 1) an acquisition step of acquiring an abnormal event history representing an abnormal event occurring in a terminal; 2) a kind determination step of determining whether a kind of the abnormal event represented by the acquired abnormal event history is a predetermined kind; 3) a terminal determination step of determining, when a kind of the abnormal event is the predetermined kind, a terminal in which the abnormal event occurs, and another terminal communicating with the terminal at or before a point when the abnormal event occurs, as output target terminals; and 4) an output step of outputting, when the abnormal event represented by the acquired abnormal event history is an abnormal event occurring in the output target terminal, output information relating to the abnormal event.

A second control method according to the present invention is executed by a computer. The control method includes: 1) an acquisition step of acquiring an abnormal event history representing an abnormal event occurring in a terminal; 2) a kind determination step of determining whether a kind of the abnormal event represented by the acquired abnormal event history is a predetermined kind; 3) a terminal determination step of determining, when a kind of the abnormal event is the predetermined kind, a terminal in which the abnormal event occurs, as an output target terminal; and 4) an output step of outputting, when the abnormal event represented by the acquired abnormal event history is an abnormal event occurring in the output target terminal, output information relating to the abnormal event.

In the output step, when a certain terminal is determined as the output target terminal, output information relating to an abnormal event occurring in the terminal earlier than the determination is further output.

A first program according to the present invention causes a computer to execute each step included in the first control method according to the present invention.

A second program according to the present invention causes a computer to execute each step included in the second control method according to the present invention.

### Advantageous Effects of Invention

According to the present invention, a technique for easing handling of information relating to an abnormal event is provided.

### BRIEF DESCRIPTION OF THE DRAWINGS

The above-described object, the other objects, features, and advantages will become more apparent from a suitable example embodiment described below and the following accompanying drawings.

FIG. 1 is a diagram illustrating an outline of an operation of a history output apparatus according to a present example embodiment.

FIG. 2 is a diagram illustrating a configuration of a history output apparatus according to an example embodiment 1.

FIG. 3 is a diagram illustrating a computer for achieving the history output apparatus.

FIG. 4 is a diagram illustrating a usage environment of the history output apparatus according to the example embodiment 1.

FIG. 5 is a flowchart illustrating a flow of processing executed by the history output apparatus according to the example embodiment 1.

FIG. 6 is a diagram illustrating an event history in a table format.

FIG. 7 is a diagram illustrating output information.

FIG. 8 is a diagram illustrating an outline of a history output apparatus according to an example embodiment 2.

FIG. 9 is a flowchart illustrating a flow of processing executed by the history output apparatus according to the example embodiment 2.

FIG. 10 is a diagram illustrating a case where a period of an output target differs depending on a kind of a command or the like.

FIG. 11 is a diagram illustrating a case where a predetermined period is extended.

### DESCRIPTION OF EMBODIMENTS

Example embodiments according to the present invention are described below by use of the drawings. Note that, a similar reference sign is assigned to a similar component in all the drawings, and description is omitted accordingly. Moreover, unless otherwise specially described, each block represents, in each block diagram, not a configuration on a hardware basis but a configuration on a function basis.

### <Outline>

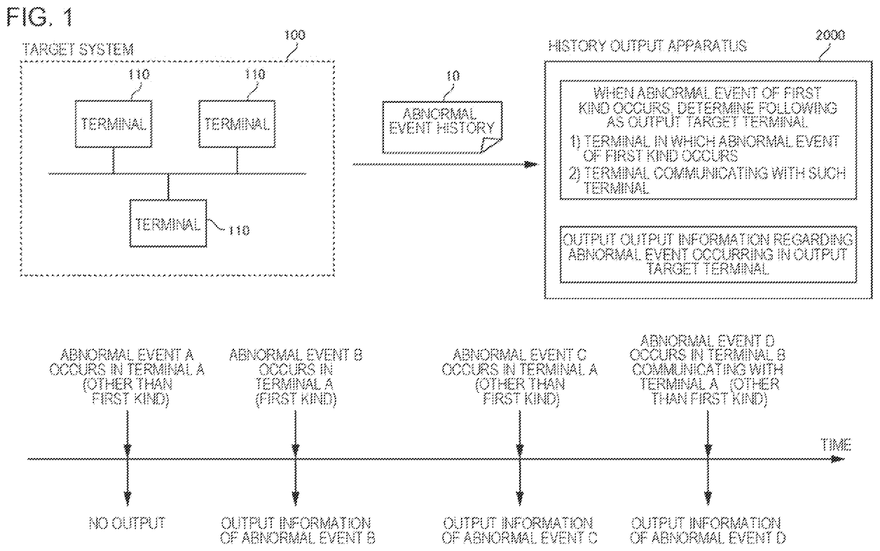

FIG. 1 is a diagram illustrating an outline of an operation of a history output apparatus 2000 according to a present example embodiment. FIG. 1 is a diagram representing conceptual description for easing understanding of the operation of the history output apparatus 2000, and does not specifically limit the operation of the history output apparatus 2000.

The history output apparatus 2000 acquires an abnormal event history 10 being information representing an abnormal event occurring in a target computer system (target system 100). The abnormal event is 1) an event that is not caused to occur by a normal program, or 2) an event that does not occur when a program is normally used. As abnormal events applying to 1), there are, for example, an event representing accessing a file that a certain program does not access when being in a normal state, an event representing communicating with a communication partner with which a certain program does not communicate when being in a normal state, and the like. For example, a program infected with malware accesses a file that the program does not access when being in a normal state. Thus, an event representing such an operation is detected as an abnormal event.

An abnormal event applying to 2) is, for example, an event occurring as a result of use of a program by a user of the program against a proper use method of the program when the proper use method is determined. For example, as a proper use method of a ping command, such a use method as “transmitting a ping command to a specific machine (e.g., a server machine), and confirming that the machine operates” is determined. In this case, it is assumed that a manager of a machine erroneously uses a ping command with a machine other than the specific machine as a destination. An event (an event representing communication with a machine other than the specific machine) occurring accordingly is against the above-described proper use method of the ping command, and therefore, is handled as an abnormal event.

The target system 100 is constituted of any one or more terminals 110. Each of the terminals 110 may be a physical machine, or may be a virtual machine. The physical machine may be a stationary machine such as a personal computer (PC), or may be a portable machine such as a smartphone. An event represents, for example, an activity (such as an access to a file or another process) performed by a process operating in a machine included in the target system.

The history output apparatus 2000 controls output (e.g., display onto a display apparatus) of the abnormal event history 10, based on a kind of an abnormal event occurring in the target system 100. Herein, it is assumed that at least a kind referred to as a first kind exists for the kind of the abnormal event. Further, it is assumed that an abnormal event that belongs to the first kind and an abnormal event that does not belong to the first kind exist for the abnormal events. An abnormal event of the first kind is, for example, an abnormal event having a high probability of representing a major abnormality. More specifically, for example, an abnormal event of the first kind is an event occurring due to execution of a command or a program for which security is not ensured. Hereinafter, “a command or a program” is also mentioned as “a command or the like”.

When acquiring the abnormal event history 10, the history output apparatus 2000 determines a kind of an abnormal event represented by the abnormal event history 10. When the determined kind of the abnormal event is the first kind, the history output apparatus 2000 determines, as an output target terminal, the terminal 110 in which the abnormal event occurs. Further, the history output apparatus 2000 also determines, as an output target terminal, another terminal 110 performing communication with the terminal 110 in which the abnormal event occurs at or before a point when the abnormal event occurs. When the abnormal event represented by the acquired abnormal event history 10 is an abnormal event occurring in an output target terminal, the history output apparatus 2000 outputs information (hereinafter, output information) relating to the abnormal event.

### Advantageous Effect

In order to prevent overlook of a major abnormality in a system, not only an event having a high probability of representing a major abnormality but also an event having a rather low probability of representing a major abnormality needs to be detected as an abnormal event. On the other hand, when information relating to an abnormal event having a rather low probability of representing a major abnormality is unconditionally output (e.g., output to a manager or the like) in this way, information relating to an abnormal event is output in large amount, and handling of information becomes difficult. As a result, such problems that overlook of a major abnormality easily occurs, a work burden of an analyzer analyzing an abnormal event is great, and a time required for analysis work is long can occur.

In order to prevent such a problem, it is suitable to restrict, to a certain degree, information to be output. In this respect, according to the history output apparatus 2000, information regarding an abnormal event that does not belong to the first kind among pieces of information relating to an abnormal event occurring in the terminal 110 is not output until an abnormal event of the first kind is detected. Thus, for example, by handling, as an event of the first kind, an abnormal event having a high probability of representing a major abnormality, information relating to an abnormal event having a rather low probability of representing a major abnormality is not output until an abnormal event having a high probability of representing a major abnormality occurs. On the other hand, after an abnormal event having a high probability of representing a major abnormality occurs, information regarding to an abnormal event having a rather low probability of representing a major abnormality also comes to be output. In this way, information relating to an abnormal event having a rather low probability of representing a major abnormality is not unconditionally output, and comes to be output along with occurrence of an abnormal event having a high probability of representing a major abnormality.

According to this approach, information to be output is appropriately restricted as compared with a case where information relating to an abnormal event is unconditionally output, and therefore, handling of information relating to an abnormal event becomes easy. This brings about such an effect that it becomes difficult for overlook of a major abnormality to occur (i.e., an improvement in analysis accuracy), a work burden of an analyzer analyzing an abnormal event is lessened, and a time required for analysis work is reduced.

For example, it is assumed that an abnormal event that occurs due to execution of a command or the like for which security is not ensured is handled as an abnormal event of the first kind. In this case, information relating to an abnormal event for which security is ensured comes to be output along with occurrence of an abnormal event for which security is not ensured. Consequently, information regarding an abnormal event for which security is ensured is appropriately restricted and output, and therefore, handling of information relating to an abnormal event becomes easy.

As an example of a case where the present invention is particularly effective, an analysis of a cyber attack using a standard command of an operating system (OS) can be cited. A standard command of an OS referred to herein is a command provided by a predetermined program (e.g., a shell program) installed together when the OS is installed. For example, malware installed on the terminal 110 intends to perform various activities (such as a search activity and infection spread) by utilizing a standard command provided by an OS operating on the terminal 110. In order to analyze such a cyber attack, information relating to an abnormal event occurring due to execution of the standard command also needs to be output.

On the other hand, not all abnormal events occurring due to execution of the standard command represent cyber attacks. For example, such a case that a user executes the standard command by an erroneous use method is conceivable. Thus, when all pieces of information relating to an abnormal event occurring due to execution of the standard command are output, a problem that the above-described analysis of information relating to a cyber attack becomes difficult arises.

Accordingly, for example, the history output apparatus 2000 is designed in such a way that an abnormal event having a high probability of representing a cyber attack is handled as an abnormal event of the first kind. For example, such an event as “document preparation software reads a password file” is handled as an abnormal event of the first kind. On the other hand, an abnormal event occurring due to execution of the standard command is considered to have a rather low probability of representing a cyber attack, and therefore, is not handled as an abnormal event of the first kind. Consequently, regarding an abnormal event occurring due to execution of the standard command, only information along with an abnormal event having a high probability of representing a cyber attack comes to be output. Thus, since information of an abnormal event relating to a cyber attack is appropriately restricted and output, handling of information relating to a cyber attack becomes easy. This brings about such an effect that accuracy of an analysis relating to a cyber attack improves, a work burden of an analyzer performing an analysis of the cyber attack is lessened, and a time required for analysis work of the cyber attack is reduced.

The history output apparatus 2000 according to the present example embodiment is described below in further detail.

### <Example of Functional Configuration of History Output Apparatus 2000>

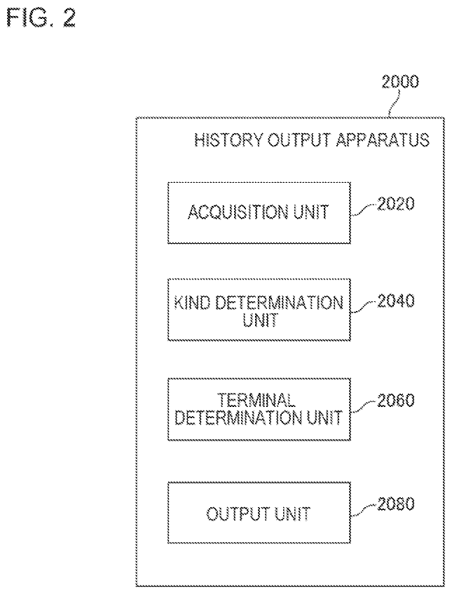

FIG. 2 is a diagram illustrating a configuration of the history output apparatus 2000 according to an example embodiment 1. The history output apparatus 2000 includes an acquisition unit 2020, a kind determination unit 2040, a terminal determination unit 2060, and an output unit 2080. The acquisition unit 2020 acquires the abnormal event history 10. The kind determination unit 2040 determines whether a kind of an abnormal event represented by the acquired abnormal event history 10 is a predetermined kind (the first kind). The terminal determination unit 2060 determines, when the determined kind of the abnormal event is the predetermined kind, the terminal 110 in which the abnormal event occurs, and another terminal 110 communicating with the terminal 110 at or before a point when the abnormal event occurs, as output target terminals. The output unit 2080 outputs, when the abnormal event represented by the acquired abnormal event history 10 is an abnormal event occurring in the output target terminal, output information relating to the abnormal event.

### <Hardware Configuration of History Output Apparatus 2000>

Each functional configuration unit of the history output apparatus 2000 may be achieved by hardware (example: a hard-wired electronic circuit, or the like) that achieves each functional configuration unit, or may be achieved by a combination of hardware and software (example: a combination of an electronic circuit and a program controlling the electronic circuit, or the like). A case where each functional configuration unit of the history output apparatus 2000 is achieved by a combination of hardware and software is further described below.

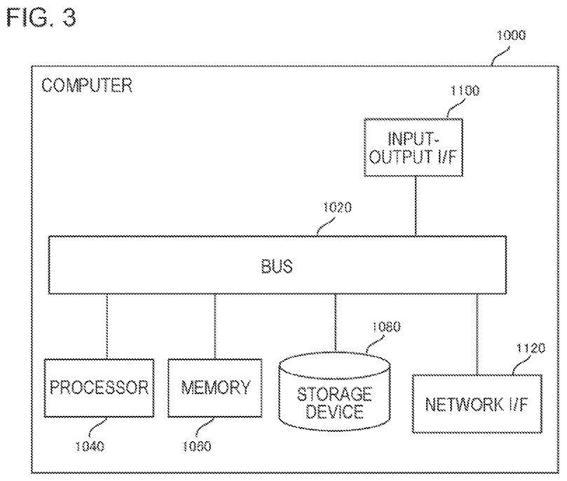

FIG. 3 is a diagram illustrating a computer 1000 for achieving the history output apparatus 2000. The computer 1000 is any computer. For example, the computer 1000 is a personal computer (PC), a server machine, a tablet terminal, a smartphone, or the like. The computer 1000 may be a dedicated computer designed in order to achieve the history output apparatus 2000, or may be a general-purpose computer.

The computer 1000 includes a bus 1020, a processor 1040, a memory 1060, a storage device 1080, an input-output interface 1100, and a network interface 1120. The bus 1020 is a data transmission path for the processor 1040, the memory 1060, the storage device 1080, the input-output interface 1100, and the network interface 1120 to mutually transmit and receive data. However, a method of connecting the processor 1040 and the like to one another is not limited to bus connection. The processor 1040 is a processor such as a central processing unit (CPU), a graphics processing unit (GPU), or a field-programmable gate array (FPGA). The memory 1060 is a main storage apparatus achieved by use of a random access memory (RAM) or the like. The storage device 1080 is an auxiliary storage apparatus achieved by use of a hard disk drive, a solid state drive (SSD), a memory card, a read only memory (ROM), or the like. However, the storage device 1080 may be configured by hardware similar to hardware configuring the main storage apparatus such as a RAM.

The input-output interface 1100 is an interface for connecting the computer 1000 and an input-output device. The network interface 1120 is an interface for connecting the computer 1000 to a communication network. The communication network is, for example, a local area network (LAN) or a wide area network (WAN). A method in which the network interface 1120 is connected to the communication network may be wireless connection, or may be wired connection.

The storage device 1080 stores a program module that achieves the functional configuration unit of the history output apparatus 2000. The processor 1040 achieves a function being associated with each program module, by reading each of the program modules into the memory 1060 and executing the program module.

### <Example of Usage Environment>

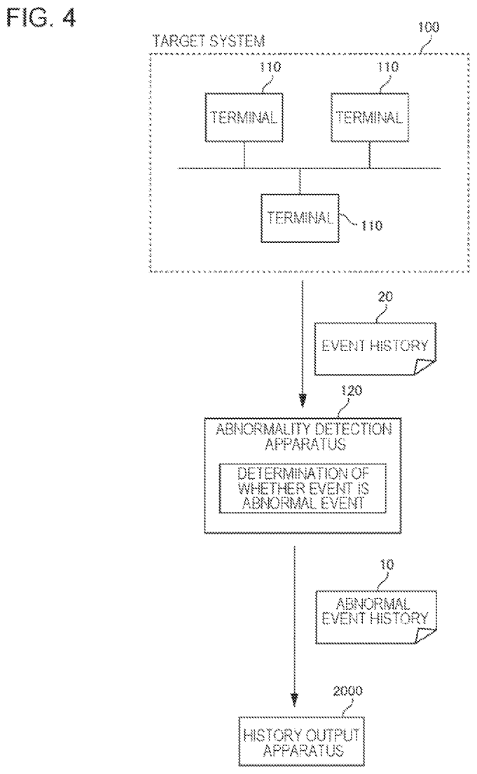

FIG. 4 is a diagram illustrating a usage environment of the history output apparatus 2000 according to the example embodiment 1. In FIG. 4, the target system 100 includes a plurality of the terminals 110. In each of the terminals 110, various commands and the like are executed. In each of the terminals 110, a history of an event representing an operation of a process and occurring due to execution of a command or the like is recorded. The history is called an event history 20. The event history 20 is collected in an abnormality detection apparatus 120. Collection of the event history 20 is achieved by, for example, regular or real-time transmission of the event history 20 to the abnormality detection apparatus 120 by the terminal 110.

The abnormality detection apparatus 120 determines whether an event represented by the event history 20 is an abnormal event. When an event represented by the event history 20 is an abnormal event, the event history 20 is handled as the abnormal event history 10.

For example, a model defining a normal event occurring in the target system 100 (in the terminal 110 included in the target system 100) is generated in advance. The abnormality detection apparatus 120 determines whether an event indicated in each event history 20 departs from the model. The abnormality detection apparatus 120 senses, as an abnormal event, an event departing from the model. Note that, an existing technique can be utilized for a technique for generating a model of a normal event, or a technique for detecting, as an abnormal event, an event departing from a model of a normal event.

The history output apparatus 2000 acquires the abnormal event history 10, and processes the acquired abnormal event history 10. Herein, there are a variety of methods in which the history output apparatus 2000 acquires the abnormal event history 10 in the event history 20. For example, the abnormality detection apparatus 120 adds, to the event history 20, a flag indicating whether the event history 20 is the abnormal event history 10, and stores the event history 20 in a storage apparatus. The acquisition unit 2020 acquires the event history 20 being associated with a flag indicating that the event history 20 is the abnormal event history 10, among the event histories 20 stored in the storage apparatus. Alternatively, for example, the abnormality detection apparatus 120 may output (e.g., transmit) the abnormal event history 10 to the acquisition unit 2020. The acquisition unit 2020 acquires the abnormal event history 10 output by the abnormality detection apparatus 120.

The abnormality detection apparatus 120 may be provided separately from the history output apparatus 2000, or may be provided within the history output apparatus 2000. In the latter case, the history output apparatus 2000 collects the event histories 20, and determines whether each of the event histories 20 represents an abnormal event. Then, the history output apparatus 2000 handles, as the abnormal event history 10, the event history 20 representing an abnormal event. Note that, the abnormality detection apparatus 120 and the history output apparatus 2000 are separately provided in FIG. 4.

### <Flow of Processing>

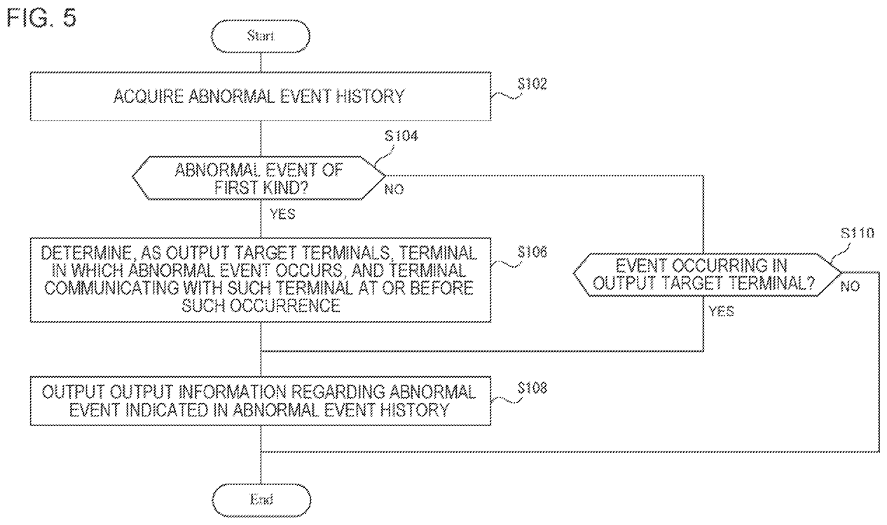

FIG. 5 is a flowchart illustrating a flow of processing executed by the history output apparatus 2000 according to the example embodiment 1. The acquisition unit 2020 acquires the abnormal event history 10 (S102). The kind determination unit 2040 determines whether a kind of an abnormal event represented by the acquired abnormal event history 10 is the first kind (S104). When the kind of the abnormal event is not the first kind (S104: NO), the processing in FIG. 5 advances to S110. When the kind of the abnormal event is the first kind (S104: YES), the terminal determination unit 2060 determines the terminal 110 in which the abnormal event occurs, and another terminal 110 communicating with the terminal 110 at or before a time when the abnormal event occurs, as output target terminals (S106).

When the abnormal event represented by the acquired abnormal event history 10 is an abnormal event occurring in the output target terminal, the output unit 2080 outputs output information regarding the abnormal event (S108). When the kind of the abnormal event indicated by the abnormal event history 10 is the first kind (S104: YES), the abnormal event is always an abnormal event occurring in the output target terminal, and therefore, the output unit 2080 outputs output information relating to the abnormal event (S108).

On the other hand, when the kind of the abnormal event indicated by the abnormal event history 10 is not the first kind (S104: NO), the output unit 2080 determines whether the abnormal event is an abnormal event occurring in the output target terminal (S110). When the abnormal event is an abnormal event occurring in the output target terminal (S110: YES), the output unit 2080 outputs output information regarding the abnormal event (S108). On the other hand, when the abnormal event is not an abnormal event occurring in the output target terminal (S110: NO), the output unit 2080 does not output output information regarding the abnormal event.

Herein, the history output apparatus 2000 acquires a plurality of the abnormal event histories 10, and performs a series of the processing illustrated in FIG. 5, in order from the abnormal event history 10 with an early occurrence time of an abnormal event. Thus, after the certain terminal 110 is determined as an output target terminal, each abnormal event history 10 representing an abnormal event occurring in the terminal 110 comes to be output by the output unit 2080.

However, after the certain terminal 110 comes to be handled as an output target terminal, the history output apparatus 2000 may not handle the terminal 110 as an output target terminal, based on a predetermined condition. For example, when, after the certain terminal 110 is determined as an output target terminal, an abnormal event of the first kind does not occur for a predetermined time or more in the terminal 110, the history output apparatus 2000 may not handle the terminal 110 as an output target terminal.

Alternatively, for example, the history output apparatus 2000 may accept, from a user, an input operation of selecting the terminal 110 that is not to be handled as an output target terminal from among the terminals 110 handled as output target terminals. For example, it is assumed that, as a result of viewing and analyzing the abnormal event history 10 output with regard to the certain terminal 110, a manager of the target system 100 determines that the terminal 110 has no problem (the abnormal event history 10 may not be output). In this case, the manager performs an input operation of removing, from the output target terminal, the terminal 110 determined as having no problem.

### <Regarding Event History 20>

The event history 20 is information relating to an event occurring in the target system 100 (in the terminal 110 included in the target system 100) at a certain past point. For example, the event history 20 indicates identification information of the terminal 110 in which an event occurs, an occurrence time of an event, and a content of an event in association with one another.

For example, the event history 20 represents a history of an activity of a process operating in the target system 100. For example, an activity of a process is recorded on a system call basis. When a certain process acts with another process as an object, the processes may be processes operating on the same operating system (OS), or may be processes operating on OSes differing from each other. As an example of the latter example, it is conceivable that a certain process performs communication with another process operating on another OS, by utilizing, for example, a socket interface.

The event history 20 indicates information relating to one or more items. Herein, for example, an event is identified by information representing five elements that are identification information of the terminal 110 in which an event occurs, a subject of an event, an object of an event, an activity content, and an occurrence time. Thus, for example, the event history 20 is broadly constituted of five elements that are identification information of the terminal 110, subject information representing a subject, object information representing of an object, content information representing a content of an activity, and an occurrence time.

The identification information of the terminal 110 is any information that can identify the terminal 110. For example, a network address (an IP address or a MAC address), a universally unique identifier (UUID), or the like of the terminal 110 can be utilized as the identification information of the terminal 110.

The subject information is, for example, a kind and identification information of the subject. The kind of the subject is, for example, a process or a socket. When a subject is a process, subject information includes information identifying the process. Hereinafter, information identifying a process is called process identification information. Specifically, process identification information includes a process identifier (ID). However, process identification information regarding a process in which a plurality of threads operate further includes a thread ID in addition to a process ID.

The process identification information further includes information relating to an execution file of a process. The information relating to an execution file of a process is, for example, a name or a path of the execution file, a hash value of the execution file, a digital signature of the execution file, a name of an application achieved by the execution file, or the like.

When a subject is a socket, subject information includes, for example, an identifier allocated to the socket.

Object information is, for example, a kind or identification information of the object. A kind of an object is, for example, a process, a file, a socket, or the like. When an object is a process, object information includes process identification information of the process.

When an object is a file, object information includes information identifying the file (hereinafter, file identification information). The file identification information is, for example, a name, a path, or the like of the file. Further, when an object is a file, object information may include a hash value of the file, a combination of an identifier of a file system and an identifier (an inode number or an object ID) of a disk block constituting a file on the file system, or the like.

When an object is a socket, object information includes, for example, an identifier allocated to the socket.

The content information is, for example, an identification information allocated to various activity contents. For example, identifiers differing from one another are allocated to contents of activities such as “execute a specified command”, “start a process”, “stop a process”, “open a file”, “read data from a file”, “write data into a file”, “open a socket”, “read data from a socket”, “write data into a socket”, and “transmit data from a socket to another socket”. Note that, access to a socket means access to another apparatus being associated with the socket.

Herein, when content information represents execution of a command, identification information of the command to be executed is also included in the content information. For example, in the event history 20 representing that a command referred to as ls is executed, “identification information of activity content: execution of command, identification information of command: ls” or the like is indicated as content information.

Note that, identification of a command may be performed by use of not content information but subject information or object information. For example, when execution of a certain command is achieved by execution of one program, an event for which identification information of the program is indicated in subject information or object information can be handled as a command representing execution of the command. In this case, identification information of the command may not be included in content information.

When an event is recorded on a system call basis, content information may indicate identification information of a system call. The identification information of a system call is, for example, a system call name or a system call number. The content information may further indicate information representing under what condition a system call is executed, such as a content of an argument (a value of the argument itself, or data stored in a memory area pointed by a pointer given as an argument) given to the system call.

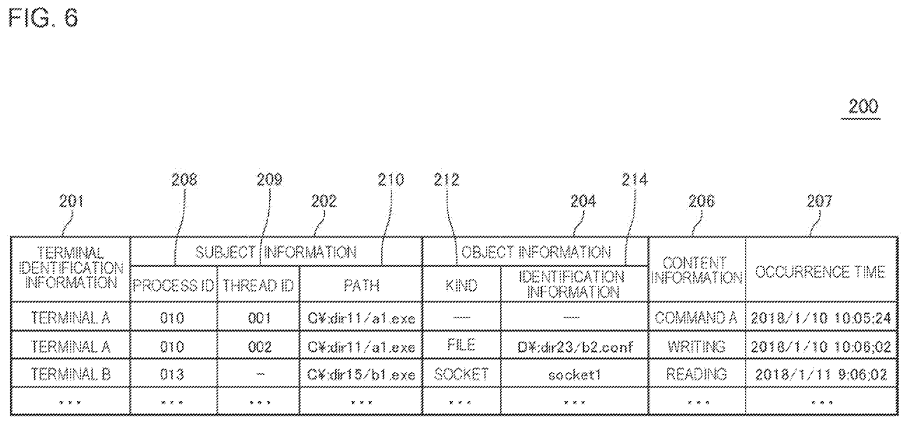

FIG. 6 is a diagram illustrating the event history 20 in a table format. Hereinafter, the table in FIG. 6 is called an event table 200. Each record in the event table 200 represents one event history 20. The event table 200 broadly includes five items that are terminal identification information 201, subject information 202, object information 204, content information 206, and an occurrence time 207. The subject information 202 includes three items that are a process ID 208, a thread ID 209, and a path 210. The object information 204 includes two items that are a kind 212 and identification information 214. The occurrence time 207 indicates a time when an event occurs.

Herein, the event history 20 is generated by recording an activity of a process on the target system. An existing technique can be utilized for a technique for recording an activity of a process.

### <Regarding Abnormal Event History 10>

The abnormal event history 10 is the event history 20 representing an abnormal event. The abnormal event history 10 may include information indicating a content of an abnormality (what abnormality occurs), in addition to a content of the event history 20.

Whether the event history 20 indicates an abnormal event is determined by, for example, the above-described abnormality detection apparatus 120. Herein, a method of determining whether an event represented by a history of the event is an abnormal event is as described above.

### <Acquisition of Abnormal Event History 10: S102>

The acquisition unit 2020 acquires the abnormal event history 10 (S102). There are a variety of methods in which the acquisition unit 2020 acquires the abnormal event history 10. For example, the acquisition unit 2020 acquires the abnormal event history 10 by receiving the abnormal event history 10 transmitted by the abnormality detection apparatus 120. Alternatively, for example, the acquisition unit 2020 acquires the abnormal event history 10 by accessing a storage apparatus storing the abnormal event history 10. Note that, a more specific method in which the acquisition unit 2020 acquires the abnormal event history 10 is as described above by use of FIG. 4.

### <Regarding Kind of Abnormal Event>

For example, an abnormal event of the first kind is an abnormal event having a high probability of representing an important abnormality. As an example of an abnormal event having a high probability of representing an important abnormality, there is, for example, an abnormal event occurring due to execution of a command or the like for which security is not ensured. Herein, regarding a command or the like, a variety of criteria can be adopted as criteria of differentiating one for which security is ensured from one for which security is not ensured. First, regarding a program is described. For example, a program determined as being secure by a manager of the target system 100 is handled as a program for which security is ensured. Alternatively, for example, a program installed together when an OS is installed is handled as a program for which security is ensured. Alternatively, for example, a program receiving a predetermined certification is handled as a program for which security is ensured. The program receiving a predetermined certification is, for example, a program given an electronic signature proving that a certification by a predetermined certification authority is received.

Alternatively, for example, whether a program is secure may be determined based on how many users there are in the target system 100. For example, when a ratio of the number of the terminals 110 in which a certain program is installed to a total number of the terminals 110 included in the target system 100 is equal to or more than a predetermined value, the program is handled as a program for which security is ensured. Alternatively, for example, in a case where a group is determined for the terminal 110, when a ratio of the number of the terminals 110 in which a certain program is installed to a total number of the terminals 110 included in the group to which the terminal 110 belongs is equal to or more than a predetermined value, the program is handled as a program for which security is ensured.

Regarding security of a command, for example, a command provided by a program for which security is ensured can be handled as a command for which security is ensured. For example, it is conceivable to handle the above-described standard command as a command for which security is ensured. In other words, an abnormal event occurring due to execution of the standard command is not handled as an abnormal event of the first kind. Thus, information relating to an abnormal event occurring due to execution of the standard command is not output until an abnormal event of the first kind is detected.

However, security of a command may be determined by a criterion different from the above-described criterion. For example, a command determined as being secure by a manager of the target system 100 is handled as a command for which security is ensured.

### <Determination of Kind of Abnormal Event: S104>

The kind determination unit 2040 determines whether a kind of the abnormal event represented by the acquired abnormal event history 10 is the first kind (S104). For example, the kind determination unit 2040 utilizes information (hereinafter, kind determination information) indicating a condition in which an abnormal event is classified into the first kind. The kind determination information is stored in advance in a storage apparatus being accessible from the kind determination unit 2040.

The above-described abnormal event of the first kind is, for example, an abnormal event occurring due to execution of a command or the like for which security is not ensured, as described above. Thus, for example, the kind determination information indicates identification information of a command or the like for which security is ensured. Then, an abnormal event occurring due to execution of a command or the like that is not indicated in the kind determination information is handled as an event of the first kind.

Identification information of a program is, for example, a name, a path, or the like of an execution file of the program. In the abnormal event history 10, identification information of an executed program is included in the above-described subject information.

Identification information of a command is, for example, a name of the command. In the abnormal event history 10, identification information of an executed command is included in the above-described subject information, object information, or content information. However, there is a case where commands of the same name are provided by programs differing from each other (e.g., shells differing from each other). In this case, for identification information of a command, a combination of identification information of a program providing the command and a name or the like of the command is utilized as identification information of the command. In this case, in the abnormal event history 10, an executed command is determined by a combination of the identification information of the program indicated in the subject information, and a name or the like of the command indicated in the content information.

The kind determination unit 2040 determines whether a kind of an abnormal event represented by the abnormal event history 10 is an abnormal event of the first kind, by comparing the abnormal event history 10 with kind determination information. For example, when a program determined by subject information of the abnormal event history 10 does not match any of programs indicated in the kind determination information, the kind determination unit 2040 determines that a kind of an abnormal event represented by the abnormal event history is an abnormal event of the first kind. On the other hand, when a program determined by subject information of the abnormal event history 10 matches any of programs indicated in the kind determination information, the kind determination unit 2040 determines that a kind of an abnormal event represented by the abnormal event history 10 is not an abnormal event of the first kind.

Alternatively, for example, when a command determined by the abnormal event history does not match any of commands indicated in the kind determination information, the kind determination unit 2040 determines that a kind of an abnormal event represented by the abnormal event history 10 is an abnormal event of the first kind. On the other hand, when a command determined by the abnormal event history 10 matches any of commands indicated in the kind determination information, the kind determination unit 2040 determines that a kind of an abnormal event represented by the abnormal event history 10 is not an abnormal event of the first kind.

### <Determination of Output Target Terminal: S106>

The terminal determination unit 2060 determines an output target terminal (S106). Specifically, when a kind of an abnormal event represented by the abnormal event history 10 is the first kind, the terminal 110 in which the abnormal event occurs, and the terminal 110 communicating with the terminal 110 at or before a time when the abnormal event occurs are determined as output target terminals. Hereinafter, in order to clarify description, the former terminal is called a first terminal, and the latter terminal is called a second terminal.

Identification information of the first terminal is indicated by the abnormal event history acquired by the acquisition unit 2020. Thus, when a kind of an abnormal event represented by the abnormal event history 10 is the first kind, the terminal determination unit 2060 determines one output target terminal (the first terminal) by identification information of the terminal 110 indicated by the abnormal event history 10.

The second terminal is determined by use of a history of communication between the terminals 110. For example, it is designed in such a way that, when the terminal 110 performs communication with another terminal 110, an event representing the communication is recorded as the event history 20. The terminal determination unit 2060 acquires identification information of the second terminal by searching a database recording the event history 20. Specifically, the terminal determination unit 2060 searches for the event history 20 satisfying both of two conditions “an occurrence time of an event is at or before an occurrence time of an abnormal event indicated by the abnormal event history 10 acquired by the acquisition unit 2020” and “identification information of the terminal 110 being a communication source or a communication destination is identification information of the first terminal”. The event history 20 acquired by the search indicates the first terminal to either the communication source or the communication destination, and indicates the second terminal to the other. Thus, the terminal determination unit 2060 can determine the second terminal.

The terminal determination unit 2060 stores, in a storage apparatus, identification information of each of the output target terminals determined by the above-described method. This enables identification information of the output target terminal to be utilized in later processing.

Note that, only the terminal 110 communicating with the first terminal not in all periods at or before a time when an abnormal event of the first kind occurs but in a predetermined period at or before a time when an abnormal event of the first kind occurs may be handled as the second terminal. A length of the predetermined period is stored in advance in a storage apparatus being accessible from the terminal determination unit 2060.

A length of the predetermined period may be common for all abnormal events of the first kind, or may differ depending on a kind of an abnormal event of the first kind. In the latter case, for example, a length of the predetermined period is determined depending on a kind of a subject (a program, a command, or the like) of an abnormal event of the first kind. For example, a longer predetermined period is set for malware having a longer latency period (a period from being infected to causing specific damage is long). As malware having a long latency period, such malware as to search for and exploit confidential information can be cited, for example. On the other hand, as malware having a short latency period (a period from being infected to causing specific damage is short), ransomware or the like can be cited, for example.

### <Determination of Whether Abnormal Event is Abnormal Event Occurring in Output Target Terminal: S110>

The output unit 2080 determines whether an abnormal event represented by the abnormal event history 10 acquired by the acquisition unit 2020 is an abnormal event occurring in the output target terminal (S110). Specifically, the output unit 2080 determines whether identification information of the terminal 110 indicated in the abnormal event history 10 matches identification information of any of output target terminals. When the identification information of the terminal 110 indicated in the abnormal event history 10 matches identification information of any of the output target terminals, the output unit 2080 determines that the abnormal event is an abnormal event occurring in the output target terminal (S110: YES). On the other hand, when the identification information of the terminal 110 indicated in the abnormal event history 10 does not match identification information of any of the output target terminals, the output unit 2080 determines that the abnormal event is not an abnormal event occurring in the output target terminal (S110: NO).

### <Output of Abnormal Event History 10: S108>

When an abnormal event represented by the abnormal event history 10 acquired by the acquisition unit 2020 is an abnormal event occurring in the output target terminal (S110: YES), the output unit 2080 outputs output information relating to the abnormal event (S108). The output information may be the acquired abnormal event history 10 itself, or may be information generated based on a content of the abnormal event history 10. For example, the output information includes an occurrence time of an abnormal event, identification information of the terminal 110 in which an abnormal event occurs, identification information of a command or the like causing an abnormal event to occur, and a content of an abnormality (what abnormality occurs).

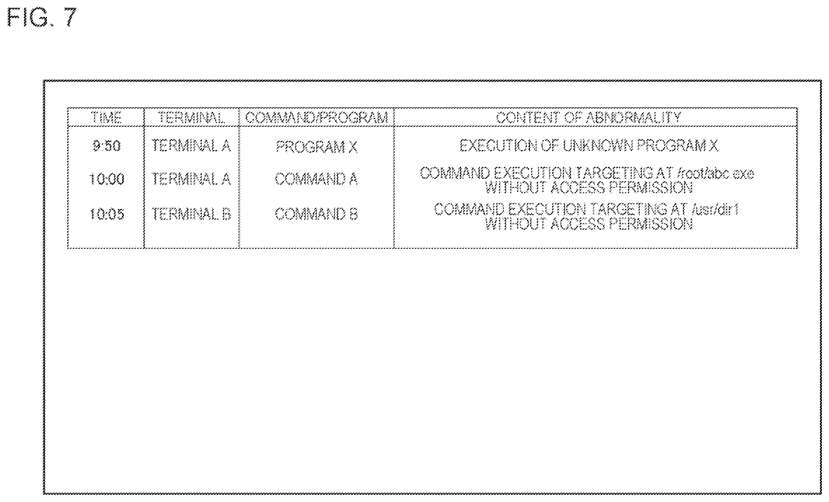

FIG. 7 is a diagram illustrating the output information. The example illustrates a case where output information is output to a display apparatus connected to the history output apparatus 2000. Moreover, in the example, it is assumed as a premise that, while a program X is a program that is not indicated in kind determination information (a program for which security is not ensured), a command A and a command B are commands indicated in kind determination information (a command for which security is ensured). Further, it is assumed that a terminal A and a terminal B perform communication before the program X is executed in the terminal A.

An abnormal event being execution of the program X and occurring in the terminal A is indicated in a first row of the output information illustrated in FIG. 7. Since the program X is not indicated in the kind determination information, the abnormal event being execution of the program X and occurring in the terminal A is determined as being an abnormal event of the first kind. Thus, the output information relating to the abnormal event is output. Note that, even when abnormal execution of the command A or the command B is performed before occurrence of an abnormal event of the first kind, output regarding the abnormal execution is not performed.

By execution of the above-described program X, the terminal A in which execution of the program X is performed is determined as an output target terminal. Further, the terminal B communicating with the terminal A at or before the occurrence time is also determined as an output target terminal. Thus, the output unit 2080 outputs output information with regard to each abnormal event occurring at or after the above-described abnormal event being execution of the program X as well. As a result, output information regarding an abnormal execution of the command A or the command B is additionally displayed on the display apparatus.

Note that, an output destination of output information is not limited to the display apparatus connected to the history output apparatus 2000. For example, the output unit 2080 may output (additionally record) output information to a predetermined stored log file. Alternatively, output information may be displayed on a display apparatus other than the display apparatus connected to the history output apparatus 2000. For example, the history output apparatus 2000 transmits output information to another apparatus. As a result, output information is displayed on a display apparatus connected to the another apparatus.

### Modification Example

The history output apparatus 2000 may further increase an output target terminal by a different method. For example, the history output apparatus 2000 may further handle, as an output target terminal, the terminal 110 communicating with any of output target terminals. This can keep, when a specific abnormality (e.g., a risk in security) propagates via communication, the propagation of the abnormality from being overlooked.

### Example Embodiment 2

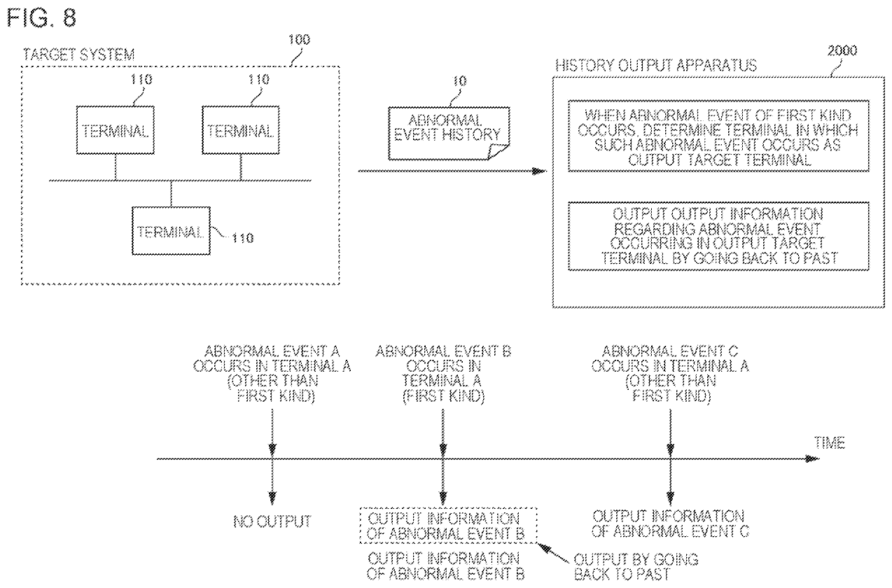

FIG. 8 is a diagram illustrating an outline of a history output apparatus 2000 according to an example embodiment 2. FIG. 8 is a diagram representing conceptual description for easing understanding of an operation of the history output apparatus 2000, and does not specifically limit the operation of the history output apparatus 2000. Except for a point specially described below, the history output apparatus 2000 according to the example embodiment 2 has a function similar to that of the history output apparatus 2000 according to the example embodiment 1.

The history output apparatus 2000 according to the example embodiment 2 is common to the history output apparatus 2000 according to the example embodiment 1 in a point that an abnormal event history 10 is output with regard to only an output target terminal.

On the other hand, the history output apparatus 2000 according to the example embodiment 2 differs from the history output apparatus 2000 according to the example embodiment 1 in the following point. First, the history output apparatus 2000 according to the example embodiment 2 may determine, as an output target terminal, at least a terminal 110 (first terminal) in which an abnormal event of a first kind occurs, and may not determine, as an output target terminal, a terminal 110 (second terminal) performing communication with the terminal. However, when a certain terminal 110 is determined as an output target terminal, the history output apparatus 2000 according to the example embodiment 2 goes back to the past and outputs the abnormal event history 10 relating to the abnormal event occurring in the terminal 110. In other words, when a certain terminal 110 is determined as an output target terminal, not only output information relating to an abnormal event occurring in the terminal 110 at and after the determination comes to be output, but also output information relating to an abnormal event occurring in the terminal 110 earlier than the determination is output.

### <Advantageous Effect>

As described above, while not only an event having a high probability of representing a major abnormality but also an event having a rather low probability of representing a major abnormality needs to be detected as an abnormal event, it is suitable to restrict, to a certain degree, information to be output with regard to the abnormal event. In this respect, the history output apparatus 2000 according to the present example embodiment does not output information regarding an abnormal event that does not belong to the first kind among pieces of information relating to an abnormal event occurring in the terminal 110, until an abnormal event of the first kind is detected. However, when an abnormal event of the first kind occurs in the terminal 110, information relating to an abnormal event is output by going back to a point before the occurrence. Thus, information relating to an abnormal event having a rather low probability of representing a major abnormality is not unconditionally output, and comes to be output along with occurrence of an abnormal event having a high probability of representing a major abnormality.

According to this approach, information to be output is appropriately restricted as compared with a case where information relating to an abnormal event is unconditionally output, and therefore, handling of information relating to an abnormal event becomes easy. This brings about such an effect that it becomes difficult for overlook of a major abnormality to occur (i.e., an improvement in analysis accuracy), a work burden of an analyzer analyzing an abnormal event is lessened, and a time required for analysis work is reduced.

Note that, as an example of a particularly effective case, an analysis of a cyber attack using a standard command of an OS can be cited, with regard to the history output apparatus 2000 according to the present example embodiment as well. Even when an abnormality resulting from a standard command occurs, it is difficult to determine by the abnormality alone whether the abnormality is an abnormality occurring as a part of a cyber attack. However, when an abnormal event having a high probability of representing a cyber attack is detected, it is considered that an abnormality resulting from a standard command occurring at or before the abnormal event has a high probability of being relevant to a cyber attack.

Thus, the history output apparatus 2000 according to the present example embodiment is designed in such a way as to handle, as an abnormal event of the first kind, an abnormal event having a high probability of representing a cyber attack. Accordingly, when an abnormal event having a high probability of representing a cyber attack occurs, information relating to an abnormal event resulting from a standard command occurring earlier also comes to be output. Consequently, information regarding an abnormality resulting from a standard command comes to be appropriately restricted and output.

The history output apparatus 2000 according to the present example embodiment is described below in further detail.

### <Example of Functional Configuration of History Output Apparatus 2000>

A functional configuration of the history output apparatus 2000 according to the example embodiment 2 is represented by FIG. 2, similarly to the history output apparatus 2000 according to the example embodiment 1. However, when a kind of an abnormal event determined by a kind determination unit 2040 is the first kind, a terminal determination unit 2060 according to the example embodiment 2 determines, as an output target terminal, the terminal 110 in which the abnormal event occurs. An output unit 2080 also outputs output information relating to an abnormal event occurring in the output target terminal earlier than the determination, in addition to outputting output information relating to an abnormal event occurring in the output target terminal at and after the determination.

### <Example of Hardware Configuration>

A hardware configuration of the history output apparatus 2000 according to the example embodiment 2 is represented by FIG. 3, for example, similarly to a hardware configuration of the history output apparatus 2000 according to the example embodiment 1. However, a program module achieving a function of the history output apparatus 2000 according to the example embodiment 2 is stored in a storage device 1080 of the history output apparatus 2000 according to the example embodiment 2.

### <Flow of Processing>

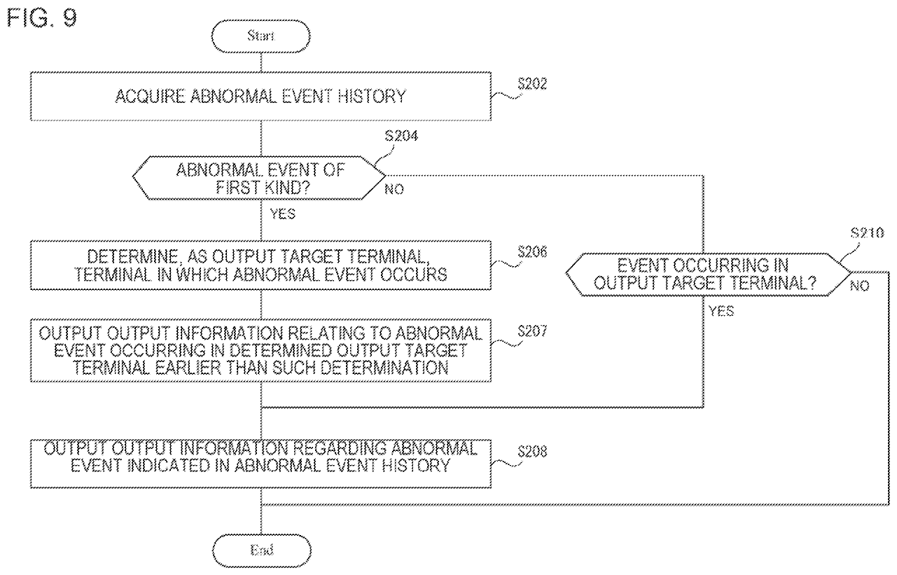

FIG. 9 is a flowchart illustrating a flow of processing executed by the history output apparatus 2000 according to the example embodiment 2. An acquisition unit 2020 acquires an abnormal event history 10 (S202). The kind determination unit 2040 determines whether a kind of an abnormal event represented by the acquired abnormal event history 10 is the first kind (S204). When the kind of the abnormal event is not the first kind (S204: NO), the processing in FIG. 9 advances to S210. When the kind of the abnormal event is the first kind (S204: YES), the terminal determination unit 2060 determines, as an output target terminal, the terminal 110 in which the abnormal event occurs (S206). With regard to the terminal 110 determined as an output target terminal, the output unit 2080 outputs output information relating to an abnormal event occurring in the terminal 110 earlier than the determination (S207).

When the abnormal event represented by the acquired abnormal event history 10 is an abnormal event occurring in the output target terminal, the output unit 2080 outputs output information regarding the abnormal event (S208). When the kind of the abnormal event indicated by the abnormal event history 10 is the first kind (S204: YES), the abnormal event is always an abnormal event occurring in the output target terminal, and therefore, the output unit 2080 outputs output information relating to the abnormal event (S208).

On the other hand, when the kind of the abnormal event indicated by the abnormal event history 10 is not the first kind (S204: NO), the output unit 2080 determines whether the abnormal event is an abnormal event occurring in the output target terminal (S210). When the abnormal event is an abnormal event occurring in the output target terminal (S210: YES), the output unit 2080 outputs output information regarding the abnormal event (S208). On the other hand, when the abnormal event is not an abnormal event occurring in the output target terminal (S210: NO), the output unit 2080 does not output output information regarding the abnormal event.

<Condition in which Output Information Relating to Past Abnormal Event is Output>

With regard to the terminal 110 determined as an output target terminal, the output unit 2080 outputs output information relating to an abnormal event occurring in the terminal 110 earlier than the determination (S207). Herein, the output unit 2080 may determine, as an output target, abnormal events occurring in all periods earlier than the determination, or may determine, as an output target, only an abnormal event occurring in a predetermined period earlier than the determination. In the latter case, the output unit 2080 determines the abnormal event history 10 whose occurrence time is included in a predetermined period (a period of a predetermined length with a determination time thereof as an endpoint) earlier than the determination, from among the abnormal event histories 10 relating to an abnormal event occurring in the terminal 110 determined as an output target terminal. Then, the output unit 2080 outputs output information with regard to the determined abnormal event history 10.

A length of the predetermined period may be common for all abnormal events, or may differ depending on an abnormal event. In the latter case, for example, a length of the predetermined period is determined depending on a kind of a command or the like causing an abnormal event to occur. To do so, information associating a length of the predetermined period with a kind of a command or the like is stored in a storage apparatus in advance.

Various kinds can be determined as kinds of commands or the like. For example, activities of such kinds as an initial survey, a search activity, and infection spread are conceivable as activities of malware. Thus, such kinds as a command or the like utilized for an initial survey, a command or the like utilized for search activity, and a command or the like utilized for infection spread are determined as kinds of commands or the like. Then, information associating identification information of the kinds with identification information of a command or the like classified into the kind is prepared. The history output apparatus 2000 recognizes a kind of a command or the like by utilizing the information.

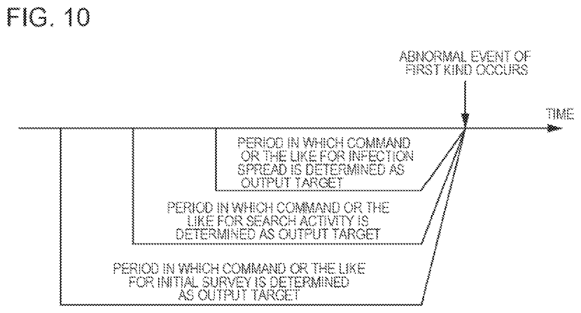

FIG. 10 is a diagram illustrating a case where a period of an output target differs depending on a kind of a command or the like. In FIG. 10, a command or the like for an initial survey, a command or the like for search activity, and a command or the like for infection spread are in descending order of output periods. A reason for this is that an activity of malware is often performed in an order of an activity of an initial survey, a search activity, and an activity of infection spread.

By changing a period of an output target depending on a kind of a command or the like in this way, output regarding an abnormal event occurring in the past can be appropriately limited. In other words, since a past abnormal event considered to have a high relevance to a detected abnormal event of the first kind is appropriately restricted, an improvement in analysis accuracy and burden reduction of analysis work can be achieved by preventing an abnormal event having a high relevance to a detected abnormal event of the first kind from not being excluded from an output target while preventing even an abnormal event having a low relevance to a detected abnormal event of the first kind from becoming an output target.

### <Extension of Predetermined Period>

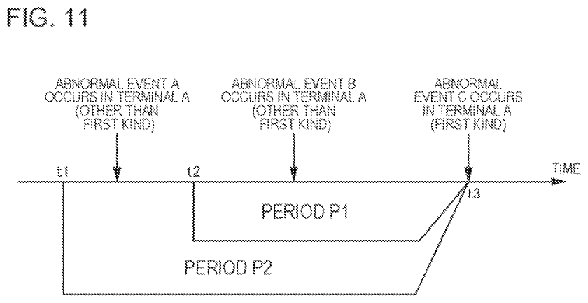

When an abnormal event occurs within the above-described predetermined period, the predetermined period may be further prolonged toward the past (the predetermined period may be extended). FIG. 11 is a diagram illustrating a case where a predetermined period is extended. In FIG. 11, an abnormal event C of the first kind occurs in a terminal A at a time t3. Thus, the output unit 2080 performs output of output information relating to the abnormal event occurring in the terminal A by going back to the past from the time t3. In this example, an abnormal event occurring in a predetermined period P1 (from t2 to t3) is determined as an output target. Herein, an abnormal event B occurs in the terminal A in the period P1. Thus, output information relating to the abnormal event B is output.

Since an abnormal event occurs in the period P1, output of output information is further performed by going back to the past. Specifically, output of output information is performed by targeting at a period P2 (from t1 to t3) having a further prolonged length of the period P1. For example, in the example of FIG. 11, an abnormal event A occurs in the terminal A in the period P2. Thus, output information representing the abnormal event A is output.

Note that, since an abnormal event occurs in the period P2 as well, output of output information may be performed by going back to a past period further than the period P2 (not illustrated). For example, the output unit 2080 repeats processing of “further going back to a past period (further prolonging a length of a period) when an abnormal event occurs back in a period”. In other words, the output unit 2080 repeatedly goes back to a past period until a situation “no abnormal event occurs back in a period”. However, an upper limit may be set for the number of times of going back (the number of times of extending a length of a period) or the like.

While the example embodiments of the present invention have been described above with reference to the drawings, the example embodiments are illustrations of the present invention, and various configurations other than those described above may be adopted. For example, output of output information by going back to the past may be performed with regard to each output target terminal according to the example embodiment 1 as described in the example embodiment 2. In other words, with regard to each of a terminal in which an abnormal event of the first kind occurs, and another terminal performing communication with the terminal before the occurrence, output information regarding an abnormal event occurring in the past (earlier than the occurrence) may be output.

Some or all of the above-described example embodiments can be described as, but not limited to, the following supplementary notes.

1. A history output apparatus including:

an acquisition unit that acquires an abnormal event history representing an abnormal event occurring in a terminal;

a kind determination unit that determines whether a kind of the abnormal event represented by the acquired abnormal event history is a predetermined kind;

a terminal determination unit that determines, when a kind of the abnormal event is the predetermined kind, a terminal in which the abnormal event occurs, and another terminal communicating with the terminal at or before a point when the abnormal event occurs, as output target terminals; and

an output unit that outputs, when the abnormal event represented by the acquired abnormal event history is an abnormal event occurring in the output target terminal, output information relating to the abnormal event.

2. The history output apparatus according to supplementary note 1, wherein

an abnormal event of the predetermined kind is an abnormal event occurring due to execution of a program or a command for which security is not ensured.

3. The history output apparatus according to supplementary note 1. or 2, wherein

a program for which security is not ensured is one or more of a program that is not installed together with an operating system, an uncertified program, and a program utilized by a predetermined number or a predetermined ratio or less of terminals, and

a command for which security is not ensured is a command provided by a program for which security is not ensured.

4. The history output apparatus according to any one of supplementary notes 1. to 3, wherein,

when a terminal determined as the output target terminal communicates with another terminal, the terminal determination unit further determines the another terminal as the output target terminal.

5. The history output apparatus according to any one of supplementary notes 1. to 4, wherein,

when a certain terminal is determined as the output target terminal, the output unit further outputs output information relating to an abnormal event occurring in the terminal earlier than the determination.

6. A history output apparatus including:

an acquisition unit that acquires an abnormal event history representing an abnormal event occurring in a terminal;

a kind determination unit that determines whether a kind of the abnormal event represented by the acquired abnormal event history is a predetermined kind;

a terminal determination unit that determines, when a kind of the abnormal event is the predetermined kind, a terminal in which the abnormal event occurs, as an output target terminal; and

an output unit that outputs, when the abnormal event represented by the acquired abnormal event history is an abnormal event occurring in the output target terminal, output information relating to the abnormal event, wherein,

when a certain terminal is determined as the output target terminal, the output unit further outputs output information relating to an abnormal event occurring in the terminal earlier than the determination.

7. The history output apparatus according to supplementary note 6, wherein,

when a certain terminal is determined as the output target terminal, the output unit further outputs the abnormal event history representing an abnormal event occurring in the terminal in a first predetermined period being earlier than the determination.

8. The history output apparatus according to supplementary note 7, wherein

a length of the first predetermined period differs depending on a kind of a program or a command causing an abnormal event to occur.

9. The history output apparatus according to supplementary note 7. or 8, wherein,

when an abnormal event occurs in the terminal in the first predetermined period, the output unit further outputs output information relating to an abnormal event occurring in the terminal in a second predetermined period being longer than the first predetermined period.

10. A control method executed by a computer, including:

an acquisition step of acquiring an abnormal event history representing an abnormal event occurring in a terminal;

a kind determination step of determining whether a kind of the abnormal event represented by the acquired abnormal event history is a predetermined kind;

a terminal determination step of determining, when a kind of the abnormal event is the predetermined kind, a terminal in which the abnormal event occurs, and another terminal communicating with the terminal at or before a point when the abnormal event occurs, as output target terminals; and

an output step of outputting, when the abnormal event represented by the acquired abnormal event history is an abnormal event occurring in the output target terminal, output information relating to the abnormal event.

11. The control method according to supplementary note 10, wherein

an abnormal event of the predetermined kind is an abnormal event occurring due to execution of a program or a command for which security is not ensured.

12. The control method according to supplementary note 10. or 11, wherein

a program for which security is not ensured is one or more of a program that is not installed together with an operating system, an uncertified program, and a program utilized by a predetermined number or a predetermined ratio or less of terminals, and

a command for which security is not ensured is a command provided by a program for which security is not ensured.

13. The control method according to any one of supplementary notes 10. to 12, further including

in the terminal determination step, when a terminal determined as the output target terminal communicates with another terminal, further determining the another terminal as the output target terminal.

14. The control method according to any one of supplementary notes 10. to 13, further including

in the output step, when a certain terminal is determined as the output target terminal, further outputting output information relating to an abnormal event occurring in the terminal earlier than the determination.

15. A control method executed by a computer, including:

an acquisition step of acquiring an abnormal event history representing an abnormal event occurring in a terminal;

a kind determination step of determining whether a kind of the abnormal event represented by the acquired abnormal event history is a predetermined kind;

a terminal determination step of determining, when a kind of the abnormal event is the predetermined kind, a terminal in which the abnormal event occurs, as an output target terminal;

an output step of outputting, when the abnormal event represented by the acquired abnormal event history is an abnormal event occurring in the output target terminal, output information relating to the abnormal event; and

in the output step, when a certain terminal is determined as the output target terminal, further outputting output information relating to an abnormal event occurring in the terminal earlier than the determination.

16. The control method according to supplementary note 15, further including

in the output step, when a certain terminal is determined as the output target terminal, further outputting the abnormal event history representing an abnormal event occurring in the terminal in a first predetermined period being earlier than the determination.

17. The control method according to supplementary note 16, wherein

a length of the first predetermined period differs depending on a kind of a program or a command causing an abnormal event to occur.

18. The control method according to supplementary note 16. or 17, further including

in the output step, when an abnormal event occurs in the terminal in the first predetermined period, further outputting output information relating to an abnormal event occurring in the terminal in a second predetermined period being longer than the first predetermined period.

19. A program causing a computer to execute each step in the control method according to any one of supplementary notes 10. to 18.

What is claimed is:

1. A history output apparatus comprising:
an acquisition unit that acquires an abnormal event history representing an abnormal event occurring in a terminal;
a kind determination unit that determines whether a kind of the abnormal event represented by the acquired abnormal event history is a predetermined kind;
a terminal determination unit that determines, when a kind of the abnormal event is the predetermined kind, a terminal in which the abnormal event occurs, and another terminal communicating with the terminal at or before a point when the abnormal event occurs, as output target terminals; and
an output unit that outputs, when the abnormal event represented by the acquired abnormal event history is an abnormal event occurring in the output target terminal, output information relating to the abnormal event.

2. The history output apparatus according to claim 1, wherein
an abnormal event of the predetermined kind is an abnormal event occurring due to execution of a program or a command for which security is not ensured.

3. The history output apparatus according to claim 1, wherein
a program for which security is not ensured is one or more of a program that is not installed together with an operating system, an uncertified program, and a program utilized by a predetermined number or a predetermined ratio or less of terminals, and
a command for which security is not ensured is a command provided by a program for which security is not ensured.

4. The history output apparatus according claim 1, wherein,
when a terminal determined as the output target terminal communicates with another terminal, the terminal determination unit further determines the another terminal as the output target terminal.

5. The history output apparatus according claim 1, wherein,
when a certain terminal is determined as the output target terminal, the output unit further outputs output information relating to an abnormal event occurring in the terminal earlier than the determination.

6. A history output apparatus comprising:
an acquisition unit that acquires an abnormal event history representing an abnormal event occurring in a terminal;
a kind determination unit that determines whether a kind of the abnormal event represented by the acquired abnormal event history is a predetermined kind;
a terminal determination unit that determines, when a kind of the abnormal event is the predetermined kind, a terminal in which the abnormal event occurs, as an output target terminal; and
an output unit that outputs, when the abnormal event represented by the acquired abnormal event history is an abnormal event occurring in the output target terminal, output information relating to the abnormal event, wherein,
when a certain terminal is determined as the output target terminal, the output unit further outputs output information relating to an abnormal event occurring in the terminal earlier than the determination.

7. The history output apparatus according to claim 6, wherein,
when a certain terminal is determined as the output target terminal, the output unit further outputs the abnormal event history representing an abnormal event occurring in the terminal in a first predetermined period being earlier than the determination.

8. The history output apparatus according to claim 7, wherein
a length of the first predetermined period differs depending on a kind of a program or a command causing an abnormal event to occur.

9. The history output apparatus according to claim 7, wherein,
when an abnormal event occurs in the terminal in the first predetermined period, the output unit further outputs output information relating to an abnormal event occurring in the terminal in a second predetermined period being longer than the first predetermined period.

10. A control method executed by a computer, comprising:
an acquisition step of acquiring an abnormal event history representing an abnormal event occurring in a terminal;
a kind determination step of determining whether a kind of the abnormal event represented by the acquired abnormal event history is a predetermined kind;
a terminal determination step of determining, when a kind of the abnormal event is the predetermined kind, a terminal in which the abnormal event occurs, and another terminal communicating with the terminal at or before a point when the abnormal event occurs, as output target terminals; and
an output step of outputting, when the abnormal event represented by the acquired abnormal event history is an abnormal event occurring in the output target terminal, output information relating to the abnormal event.

11. The control method according to claim 10, wherein
an abnormal event of the predetermined kind is an abnormal event occurring due to execution of a program or a command for which security is not ensured.

12. The control method according to claim 10, wherein
a program for which security is not ensured is one or more of a program that is not installed together with an operating system, an uncertified program, and a program utilized by a predetermined number or a predetermined ratio or less of terminals, and
a command for which security is not ensured is a command provided by a program for which security is not ensured.

13. The control method according to claim 10, further comprising
in the terminal determination step, when a terminal determined as the output target terminal communicates with another terminal, further determining the another terminal as the output target terminal.

14. The control method according to claim 10, further comprising
in the output step, when a certain terminal is determined as the output target terminal, further outputting output information relating to an abnormal event occurring in the terminal earlier than the determination.

15. A control method executed by a computer, comprising:
an acquisition step of acquiring an abnormal event history representing an abnormal event occurring in a terminal;
a kind determination step of determining whether a kind of the abnormal event represented by the acquired abnormal event history is a predetermined kind;
a terminal determination step of determining, when a kind of the abnormal event is the predetermined kind, a terminal in which the abnormal event occurs, as an output target terminal;
an output step of outputting, when the abnormal event represented by the acquired abnormal event history is an abnormal event occurring in the output target terminal, output information relating to the abnormal event; and
in the output step, when a certain terminal is determined as the output target terminal, further outputting output information relating to an abnormal event occurring in the terminal earlier than the determination.

16. The control method according to claim 15, further comprising
in the output step, when a certain terminal is determined as the output target terminal, further outputting the abnormal event history representing an abnormal event occurring in the terminal in a first predetermined period being earlier than the determination.

17. The control method according to claim 16, wherein
a length of the first predetermined period differs depending on a kind of a program or a command causing an abnormal event to occur.

18. The control method according to claim 16, further comprising
in the output step, when an abnormal event occurs in the terminal in the first predetermined period, further outputting output information relating to an abnormal event occurring in the terminal in a second predetermined period being longer than the first predetermined period.

19. A non-transitory computer readable medium having recorded thereon a program causing a computer to execute each step in the control method according to claim 10.

20. A non-transitory computer readable medium having recorded thereon a program causing a computer to execute each step in the control method according to claim 15.
